(19) United States
(12) Patent Application Publication
(10) Pub. No.: US 2009/0090315 A1
(43) Pub. Date: Apr. 9, 2009

(54) HORIZONTALLY OPPOSED ENGINE

(75) Inventor: Masahiro UCHIDA, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/180,633

(22) Filed: Jul. 28, 2008

(30) Foreign Application Priority Data
Oct. 3, 2007 (JP) 2007-259554

(51) Int. Cl. F02B 75/24

(52) U.S. Cl. 123/53.6

(57) ABSTRACT

A horizontally opposed engine includes a first cylinder and a second cylinder, a first camshaft, a second camshaft, a crankshaft side sprocket, a first camshaft side sprocket, a second camshaft side sprocket, and a timing chain wound around the sprockets. The timing chain is wound so that it extends substantially parallel with an axis of the cylinders extending between the first camshaft side sprocket and the second camshaft side sprocket. An upper chain guide defines a guide rail that is arranged to ensure that the timing chain extends straight. The horizontally opposed engine has a single timing chain that is arranged to transmit a rotation of a crankshaft to a camshaft in each cylinder, and that is resistant to the effects of elongation of the timing chain.

### BACKGROUND OF THE INVENTION

1. Field of the Invention

The present invention relates to a horizontally opposed engine in which rotation of a crankshaft is transmitted to camshafts of a pair of cylinders by a single timing chain.

2. Description of the Related Art

An example of a conventional horizontally opposed engine is described in JP-Y-Hei 6-40883. The horizontally opposed engine disclosed in JP-Y-Hei 6-40883 includes first and second cylinders extending horizontally in two opposing directions from a crankshaft when viewed from an axial direction of the crankshaft, a first camshaft disposed in the first cylinder, a second camshaft disposed in the second cylinder, and a camshaft drive unit for transmitting rotation of the crankshaft to the first and the second camshafts.

The conventional camshaft drive unit includes a crankshaft side pulley attached to the crankshaft, a first camshaft side pulley attached to the first camshaft, a second camshaft side pulley attached to the second camshaft, a plurality of idler pulleys and tension pulleys, a timing belt wound around these pulleys, and so forth.

The crankshaft side pulley is coupled to an upper portion of the timing belt extending from the upper end of the first camshaft side pulley to the upper end of the second camshaft side pulley. A guide rail of the upper portion of the timing belt is curved by the idler pulleys and the tension pulleys so that the timing belt engages with the crankshaft side pulley with a predetermined number of teeth.

On the other hand, a water pump drive pulley positioned below is in contact with a lower portion of the timing belt extending from the lower end of the first camshaft side pulley to the lower end of the second camshaft side pulley. A guide rail of the lower portion of the timing belt is curved by two idler pulleys so that the timing belt winds around the water pump drive pulley at a predetermined contact angle.

That is, both guide rails of the upper and the lower portions of the timing belt in the horizontally opposed engine disclosed in JP-Y-Hei 6-40883 are curved.

The timing belt in JP-Y-Hei 6-40883 is quite long as a result of its many curved portions. If the timing belt is substituted with a long timing chain, valve timing may become inaccurate due to a changing length of the chain. This change in length occurs because the teeth on a sprocket have a tendency to stretch a chain until they are able to comfortably fit within a gap. Accordingly, chains are much more likely to stretch than belts.

That is, for example, when a length of a chain wound around a sprocket attached to a first camshaft and a sprocket attached to a second camshaft becomes stretched, the first camshaft and the second camshaft do not rotate synchronously. Thereby, the valve timing becomes inaccurate as described above.

### SUMMARY OF THE INVENTION

In order to overcome the problems described above, preferred embodiments of the present invention provide a horizontally opposed engine, which is substantially compact in an axial direction of a crankshaft by replacing a conventional timing belt with a timing chain having a relatively narrow width.

A preferred embodiment of the present invention provides a horizontally opposed engine having a single timing chain arranged to transmit rotation of a crankshaft to a camshaft in each cylinder wherein the timing chain is resistant to the effects of elongation.

A horizontally opposed engine according to a preferred embodiment of the present invention preferably includes a first cylinder and a second cylinder extending respectively in opposing directions from a crankshaft when viewed from an axial direction of the crankshaft; a first camshaft disposed in the first cylinder; a second camshaft disposed in the second cylinder; a crankshaft side sprocket disposed on the crankshaft; a first camshaft side sprocket disposed on the first camshaft; a second camshaft side sprocket disposed on the second camshaft; a single timing chain wound around these sprockets, in which the timing chain is wound so that it extends in a straight direction that is substantially parallel with an axis of the cylinder that extends between the first camshaft side sprocket and the second camshaft side sprocket; and a chain guide defining a guide rail for the timing chain.

In a preferred embodiment of the present invention, an auxiliary drive sprocket is preferably engaged with a portion of the timing chain that extends along the chain guide, and the auxiliary drive sprocket is made of material having a lower hardness than that of the timing chain.

In a preferred embodiment of the present invention, the chain guide is preferably disposed above the crankshaft side sprocket, a portion of the timing chain positioned higher than the first and the second camshaft side sprockets is held by the chain guide, a portion of the timing chain positioned below the first and the second camshaft side sprockets is engaged with the crankshaft side sprocket and an oil pump drive sprocket, the oil pump drive sprocket is preferably positioned at about the same height as an oil pan disposed below the first and the second cylinders, and a space surrounding the oil pump drive sprocket is connected to the oil pan.

A preferred embodiment of the present invention further includes a first cylinder body defining a portion of the first cylinder and a second cylinder body defining a portion of the second cylinder, in which the first and the second cylinder bodies are configured to oppose each other, and the oil pump is attached to a portion of the one cylinder body facing a portion of the other cylinder body.

In a preferred embodiment of the present invention, a portion of the timing chain wound between the first camshaft side sprocket and the second camshaft side sprocket is minimized. Therefore, in the horizontally opposed engine according to a preferred embodiment of the present invention, although rotation of the crankshaft is transmitted to the first camshaft and the second camshaft through the single timing chain, engine operation is hardly affected by any elongation of the timing chain, and the valve timing is kept precise for a long period of time.

As a result of the present preferred embodiment, rotation of the crankshaft can be transmitted to the camshafts using a single timing chain. Therefore, the size of a horizontally opposed engine can be decreased in an axial direction of the crankshaft. Also, the fact that the timing chain, which extends straight between the first camshaft side sprocket and the second camshaft side sprocket, does not excessively overhang these sprockets also contributes to a decreased engine size.

According to another of preferred embodiment of the present invention, the auxiliary drive sprocket is preferably made of material having relatively low hardness and is coupled with a portion of the timing chain that extends along the chain guide. Accordingly, it is easier for the teeth of the auxiliary drive sprocket to deform elastically as opposed to the timing chain. Therefore, when the timing chain impacts the auxiliary drive sprocket, an elastic deformation of the teeth will absorb the impact.

Also, because the auxiliary drive sprocket couples with the timing chain through only a small number of teeth, breakage of the auxiliary drive sprocket due to an impact from the timing chain can be prevented. In addition, the timing chain is not ground by the teeth because the impact is absorbed as is described above. Therefore, the wear of the teeth can be minimized.

According to another preferred embodiment of the present invention, a space surrounding the oil pump drive sprocket is connected to the oil pan. The oil pump drive sprocket and a portion of the timing chain wound around the sprocket can be coated in oil. Therefore, according to the present preferred embodiment, the sprocket and the timing chain can be lubricated with oil that has dripped into the oil pan.

According to another preferred embodiment of the present invention, the oil pump is preferably attached to a portion in one cylinder body that opposes the other cylinder body. Accordingly, attaching and detaching the oil pump to the cylinder body can be performed without having to detach the cylinder bodies, or provide an open space around the oil pump. In other words, the oil pump can be easily attached or detached even when it is positioned within the engine.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a plan view illustrating a general configuration of a horizontally opposed engine according to a preferred embodiment of the present invention.

FIG. 2 is a front view illustrating a general configuration of the horizontally opposed engine according to a preferred embodiment of the present invention.

FIG. 3 is a front view of the horizontally opposed engine according to a preferred embodiment of the present invention.

FIG. 4 is a cross-sectional view of a lower portion of a first cylinder body and an oil pump.

FIG. 5 is a side view of a lower portion of a right cylinder body.

FIG. 6 is a cross-sectional view taken along the line VI-VI in FIG. 5.

FIG. 7 is a cross-sectional view of a water pump.

FIG. 8 is a front view of a horizontally opposed engine illustrating another preferred embodiment of the present invention.

### DETAILED DESCRIPTION OF PREFERRED EMBODIMENTS

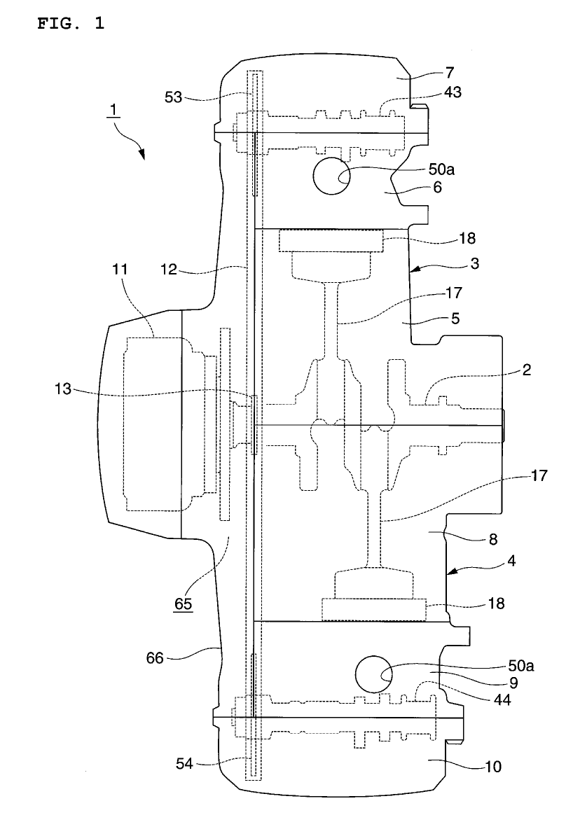

Description will hereinafter be made of the preferred embodiments of a horizontally opposed engine according to the present invention with respect to FIG. 1 through FIG. 7.

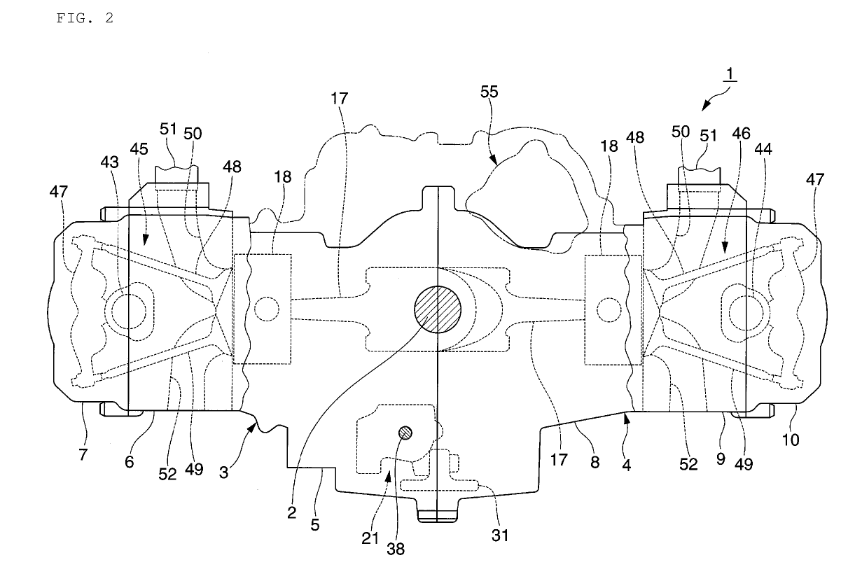

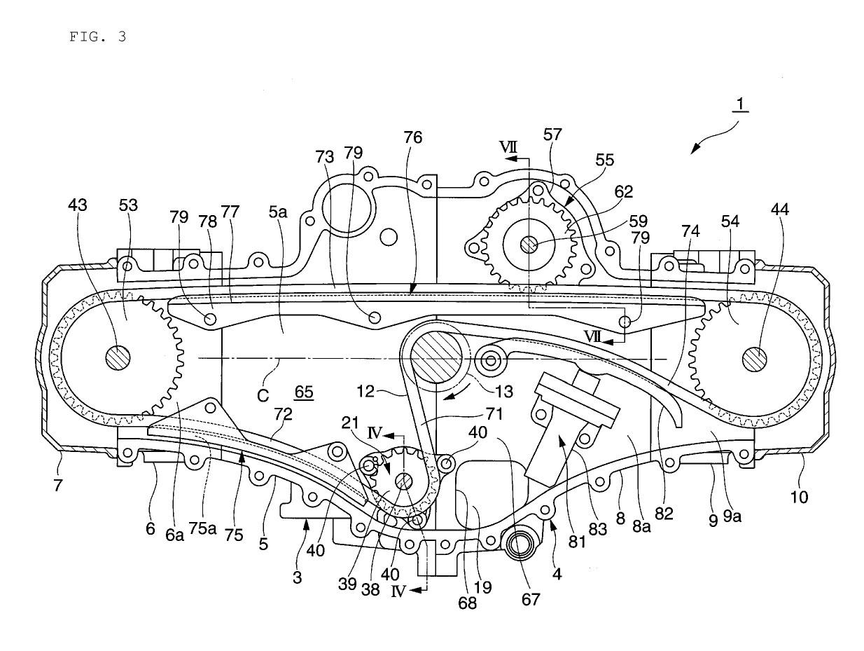

FIG. 1 is a plan view illustrating a general configuration of the horizontally opposed engine according to a preferred embodiment of the present invention. FIG. 2 is a front view corresponding to FIG. 1. FIG. 3 is a front view of the horizontally opposed engine according to a preferred embodiment of the present invention. FIG. 3 is illustrated without a front cover and with a head cover in breakaway.

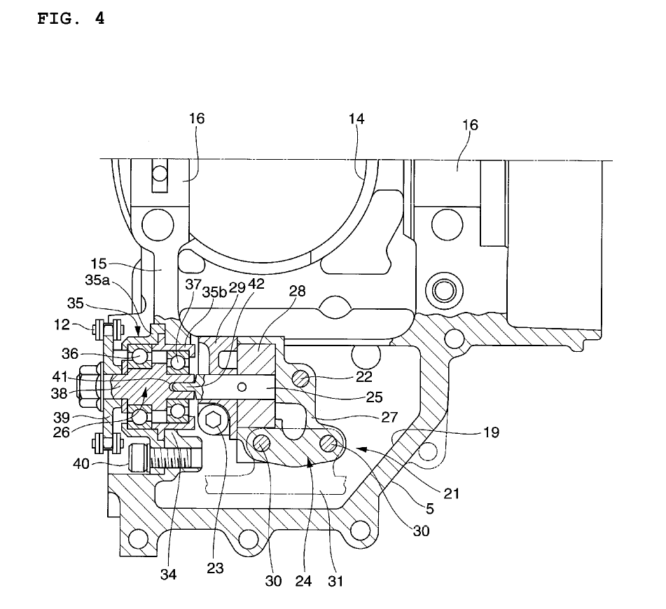

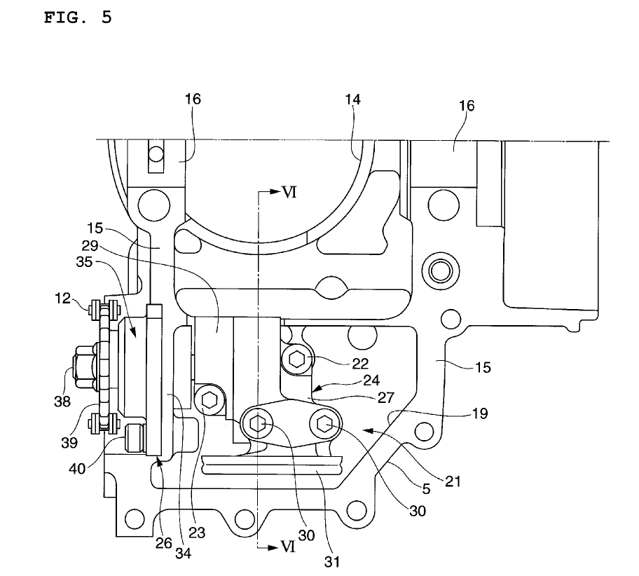

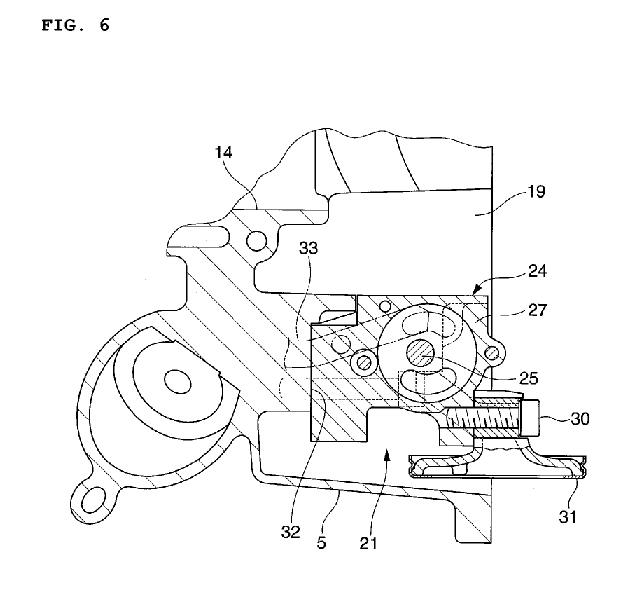

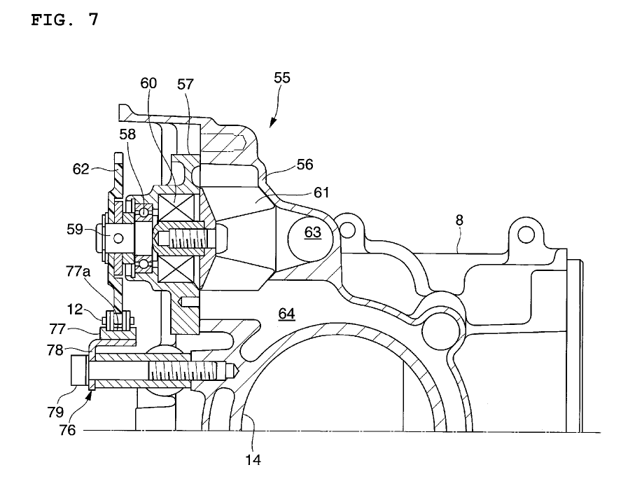

FIG. 4 is a cross-sectional view of a lower portion of a first cylinder body and an oil pump, taken along the line IV-IV in FIG. 3. FIG. 5 is a side view of a lower portion of a right cylinder body. FIG. 6 is a cross-sectional view taken along the line VI-VI in FIG. 5, in which a rotor of the oil pump has been omitted. FIG. 7 is a cross-sectional view of a water pump taken along the line VII-VII in FIG. 3.

In the drawings, reference numeral 1 denotes a horizontally opposed engine of a preferred embodiment of the present invention. The horizontally opposed engine 1 is preferably mounted on an airframe of an unmanned helicopter (not shown), for example. As shown in FIG. 2, the horizontally opposed engine 1 includes a first cylinder 3 and a second cylinder 4 extending horizontally in one direction and in another direction from a crankshaft 2 when viewed from an axial direction of the crankshaft 2. The engine 1 is mounted on the airframe in such a manner that an axis of the crankshaft 2 is directed in a fore-and-aft direction of the airframe, the first cylinder 3 is positioned on the right side of the airframe and the second cylinder 4 is positioned on the left side of the airframe.

As shown in FIG. 1, the first cylinder 3 includes a first cylinder body 5, a first cylinder head 6, a first head cover 7 and so forth. The second cylinder 4 includes a second cylinder body 8, a second cylinder head 9, a second head cover 10 and so forth.

The crankshaft 2 is held between and rotatably supported by the first cylinder body 5 and the second cylinder body 8. One end (front end) of the crankshaft 2 positioned in the front side of the airframe (left side in FIG. 1) and protrudes forward with respect to the first and the second cylinder bodies 5, 8. As shown in FIG. 1, in this protruding portion, a flywheel magneto 11 and a crankshaft side sprocket 13 wound with a timing chain 12, which will be described below, are provided. The rotational direction of the crankshaft 2 is clockwise in FIG. 3.

The first cylinder body 5 and the second cylinder body 8 are respectively provided with a cylinder hole 14 (see FIGS. 4 and 5) and coupled to the crankshaft 2 to hold the crankshaft 2 therebetween. Accordingly, as shown in FIGS. 4 and 5, a mating surface 15 to which an opposing cylinder body is attached is arranged between opposing side surfaces of the first cylinder body 5 and the second cylinder body 8, and a bearing 16 is provided to rotatably support the crankshaft 2.

As shown in FIGS. 1 and 2, pistons 18 connected to the crankshaft 2 via connecting rods 17 are inserted in the cylinder holes 14.

As shown in FIGS. 4 and 5, an oil pan 19 is defined integrally with the lower ends of the first and the second cylinder bodies 5, 8. An oil pump 21 is provided in the oil pan 19.

As shown in FIGS. 4 to 6, the oil pump 21 includes a pump main body 24 attached to the first cylinder body 5 with attachment bolts 22, 23 and an idler unit 26 arranged to transmit rotation of the timing chain 12 to a rotary shaft 25 of the pump main body 24. As shown in FIG. 3, the oil pump 21 according to the present preferred embodiment is preferably positioned below the crankshaft 2 and at about the same height of the oil pan 19 as shown in FIGS. 4 and 5.

As shown in FIG. 4, the pump main body 24, such as a so-called trochoid pump, includes a pump body 27 through which the attachment bolts 22, 23 pass, a rotatable rotor 28 in the pump body 27, a cover 29 for closing an opening of the pump body 27, the rotary shaft 25 passing through the cover 29 and extending in a fore-and-aft direction, a strainer 31 attached to the pump body 27 with an attachment bolt 30, and so forth. The rotor 28 is connected to an end of the rotary shaft 25 positioned in the rear side (right side in FIG. 4) of the airframe. The idler unit 26, which will be described below, is connected to the other end of the rotary shaft 25 positioned in the front side of the airframe.

As shown in FIG. 6, the pump main body 24 is attached to a mounting seat 32 provided in the first cylinder body 5 to face the second cylinder body 8 such that an axis line of the rotary shaft 25 extends substantially parallel with the crankshaft 2. That is, the pump main body 24 is attached to a portion of the first cylinder body 5 facing the second cylinder body 8.

The pump main body 24 pumps oil in the oil pan 19 through the strainer 31 with the rotation of the rotary shaft 25 and discharges the oil into an oil supply passage 33 (see FIG. 6). The oil supply passage 33 is connected to each of the lubricated portions in the engine 1.

As shown in FIG. 4, the idler unit 26 includes a cylindrical housing 35 passing through a vertical wall 34, which defines the oil pan 19 and is positioned in the front side of the airframe; an idler shaft 38 rotatably supported inside the housing 35 by bearings 36, 37; and an oil pump drive sprocket 39 fixed to an end of the idler shaft 38 and positioned in the front side (left side in FIG. 4) of the airframe.

The housing 35 is formed from a plurality of cylindrical bodies 35a, 35b and attached to a front end of the first cylinder body 5 and the second cylinder body 8 with an attachment bolt 40 in such a manner that an axis line of the idler shaft 38 extends substantially parallel with a fore-and-aft direction of the airframe.

A concave groove 41 extending in a radial direction is provided at a rear end of the idler shaft 38. A plate-shaped member 42 provided on the rotary shaft 25 of the pump main body 24 is loosely fitted in the concave groove 41. Rotation of the idler shaft 38 is transmitted to the rotary shaft 25 via the fitting between the concave groove 41 and the plate-shaped member 42.

Thus, the idler shaft 38 is connected to the rotary shaft 25 with the above described construction. Therefore, if either the vertical wall 34 or the housing 35 elastically deforms because of tension applied to the idler shaft 38 by the timing chain 12, which in turn causes a tilt the idler shaft 38, the rotary shaft 25 preferably will not tilt which allows the rotor 28 of the pump main body 24 to rotate smoothly.

Also, because both shafts 25, 38 are connected to each other through the fitting, the pump main body 24 can be detached from the cylinder body 5 by itself without removing the idler unit 26 from the cylinder body 5. Accordingly, maintenance of the pump main body 24 can be easily performed.

As shown in FIGS. 1 to 3, the first cylinder head 6 and the second cylinder head 9 are respectively attached to outer ends of the first cylinder body 5 and the second cylinder body 8. As shown in FIG. 2, the first and the second cylinder heads 6, 9 have valve systems 45, 46 including camshafts 43, 44. The valve systems 45, 46 drive intake valves 48 and exhaust valves 49 by converting rotation of the camshafts 43, 44 into reciprocating motion via rocker arms 47. The camshafts 43, 44 rotate with the rotation of the crankshaft 2 that is transmitted by the timing chain 12, which will be described below.

The intake valves 48 are positioned in the upper portion of the first and the second cylinder heads 6, 9 while the exhaust valves 49 are positioned in the lower portion of the first and the second cylinder heads 6, 9. Intake ports 50, at which the intake valves 48 open or close, open to upper ends of the first and the second cylinder heads 6, 9. Intake pipes 51 (see FIG. 2) are connected to openings 50a (see FIG. 1) of the intake ports 50. Exhaust ports 52 that are opened or closed by the exhaust valves 49 have openings on lower ends of the first and the second cylinder heads 6, 9 that are connected to exhaust pipes (not shown) attached thereto.

As shown in FIGS. 1 and 3, a first camshaft side sprocket 53, around which the timing chain 12 is wound, is attached to an end of the camshaft 43 (hereinafter referred to as a first camshaft 43) provided in the first cylinder head 6 that is positioned in the front side of the airframe.

A second camshaft side sprocket 54, around which the timing chain 12 is wound, is attached to an end of the camshaft 44 (hereinafter referred to as a second camshaft 44) provided in the second cylinder head 9 that is positioned in the front side of the airframe.

As shown in FIG. 3, a water pump 55 is attached to the upper portion of the second cylinder body 8. As shown in FIG. 7, the water pump 55 includes a pump housing 56 positioned in the front side (left side in FIG. 7) of the airframe and extending in a forward direction of the airframe at an upper end of the second cylinder body 8; a pump cover 57 attached to the second cylinder body 8 to close an opening of the pump housing 56; a rotary shaft 59 rotatably supported by the pump cover 57 via a bearing 58; a seal member 60 interposed between the rotary shaft 59 and the pump cover 57; an impeller 61 fixed to an end of the rotary shaft 59 positioned in the rear side of the airframe; and a water pump drive sprocket 62 fixed to an end of the rotary shaft 59 in the front side of the airframe. Although not shown in the figures, the seal member 60 preferably includes two lips; a lip for sealing oil and a lip for sealing cooling water.

The rotary shaft 59 is supported by the pump cover 57 in such a manner that an axis thereof is substantially parallel to a fore-and-aft direction of the airframe. In the present preferred embodiment, the water pump drive sprocket 62 is preferably made of a resin or plastic and is coupled with the timing chain 12. In the present preferred embodiment, the water pump drive sprocket 62 is provided as an auxiliary drive sprocket.

The water pump 55 according to the present preferred embodiment pumps cooling water from a cooling water inflow passage 63 in the second cylinder body 8 and discharges it into a cooling water outflow passage 64. The cooling water inflow passage 63 is preferably connected to a radiator (not shown). The cooling water outflow passage 64 is connected to each water jacket in the engine 1.

As shown in FIG. 3, the timing chain 12 is wound around each of sprockets 13, 39, 53, 54 in order to ensure that the timing chain 12 passes along front surfaces 5a, 8a of the first and second cylinder bodies 5, 8 and front surfaces 6a, 9a of the first and second cylinder heads 6, 9. The timing chain 12 according to the present preferred embodiment is housed in a chain chamber 65 (see FIG. 3) provided in the front end of the engine 1.

As shown in FIG. 1, the chain chamber 65 is defined by the inside of a front cover 66 attached to the front ends of the first and the second cylinder bodies 5, 8; the front ends of the first and the second cylinder heads 6, 9; and the first and the second head covers 7, 10. By attaching the front cover 66 to the front end of the engine 1, a space inside the first head cover 7 and a space inside the second head cover 10 can be connected with each other via the chain chamber 65.

As shown in FIG. 3, the chain chamber 65 is connected to the oil pan 19 via an opening 68 formed in a vertical wall 67 of the second cylinder body 8 positioned in the front side of the airframe. The opening 68 connects the lowermost portion of the oil pan 19 and the lowermost portion of the chain chamber 65. That is, a space surrounding the oil pump drive sprocket 39 is connected to the oil pan 19 through the opening 68. As a result, oil in the oil pan 19 can flow into the lower portion of the chain chamber 65 through the opening 68.

In the engine 1 of the present preferred embodiment, the level of the oil in the oil pan 19 is arranged to be generally the same as or higher than the lower end of the oil pump drive sprocket 39 during operation of the engine. Accordingly, the oil pump drive sprocket 39 and a portion of the timing chain 12 wound around the sprocket are coated by the oil that flows in the chain chamber 65 through the opening 68.

The timing chain 12 is wound around each of the sprockets so that a power transmission path can be defined by the crankshaft side sprocket 13, the oil pump drive sprocket 39, the first camshaft side sprocket 53, and the second camshaft side sprocket 54. That is, as shown in FIG. 3, the timing chain 12 includes a vertically extending section 71 extending vertically between the crankshaft side sprocket 13 and the oil pump drive sprocket 39; a first laterally extending section 72 extending laterally between the oil pump drive sprocket 39 and the first camshaft side sprocket 53; a second laterally extending section 73 extending in a direction substantially parallel with an axis C of the cylinder between the first camshaft side sprocket 53 and the second camshaft side sprocket 54; a third laterally extending section 74 extending laterally between the second camshaft side sprocket 54 and the crankshaft side sprocket 13; and so forth.

The second laterally extending section 73 defines a portion of the timing chain higher than the first and the second camshaft sprockets according to the present preferred embodiment. The vertically extending section 71 and the first and the third laterally extending sections 71, 74 define a portion of the timing chain lower than the first and the second camshaft sprockets according to the present preferred embodiment.

A lower chain guide 75, attached to the lower portion of the first cylinder body 5 and the lower portion of the first cylinder head 6, limits the movement of the first laterally extending section 72 in both an axial direction of the crankshaft 2 (forward and backward with respect to the airframe) and in the downward direction.

The movement of the second laterally extending section 73 in an axial direction of the crankshaft 2 and in the downward direction is limited by an upper chain guide 76 attached to the upper portions of the first and the second cylinder bodies 5, 8 and the upper portions of the first and the second cylinder heads 6, 9.

As shown in FIG. 7, the upper chain guide 76 includes a guide rail 77 arranged to limit the motion of the timing chain 12 and a bracket 78 arranged to attach the guide rail 77 to the engine 1. As shown in FIG. 3, the upper chain guide 76 defines a guide rail for the timing chain 12 extending substantially parallel with an axis C of the cylinder. The upper chain guide 76 defines a chain guide according to the present preferred embodiment.

The guide rail 77 is constructed such that a concave groove 77a (see FIG. 7), into which the timing chain 12 is inserted from above, limits the moving direction of the timing chain 12. As shown in FIG. 3, the guide rail 77 according to the present preferred embodiment is arranged in such a manner that the center (a portion positioned above the crankshaft 2) in a longitudinal direction when viewed from the axial direction of the crankshaft 2 is preferably positioned slightly higher than both of its ends. In other words, the guide rail 77 is defined by an upwardly facing convex shape. Accordingly, the second laterally extending section 73 of the timing chain 12 extends along the guide rail 77 in a substantially parallel direction with the axis C as viewed from the axial direction of the crankshaft 2.

The bracket 78 of the upper chain guide 76 is arranged to support the guide rail 77 from below, and is attached to the first and the second cylinder bodies 5, 8 and the first cylinder head 6 by a plurality of attachment bolts 79. The lower chain guide 75, which is arranged differently from the upper chain guide 76, defines a guide rail for the aforementioned first laterally extending section 72 that is constructed such that a guide rail 75a (see FIG. 3) having a concave groove (not shown) is suspended from a portion spaced above the timing chain 12.

As shown in FIGS. 3 and 7, the aforementioned water pump drive sprocket 62 couples with the second laterally extending section 73 of the timing chain 12 from above. Because the second laterally extending section 73 extends substantially parallel with the axis C of the cylinder, the number of teeth of the water pump drive sprocket 62 which couple with the timing chain 12 preferably does not exceed four.

As shown in FIG. 3, the third laterally extending section 74 of the timing chain 12 is urged upward by a hydraulic chain tensioner 81. The hydraulic chain tensioner 81 includes a rail 82 contacting the timing chain 12 from below and a tensioner body 83 arranged to apply a force to the rail 82. The rail 82 is pivotally supported by the second cylinder body 8 about one end positioned in proximity to the crankshaft 2. The tensioner body 83 is fixed to the second cylinder body 8, and adapted to press the longitudinal center of the rail 82 obliquely upward by way of a spring member and a hydraulic circuit (not shown). The spring member provides an initial tension of the chain when hydraulic pressure is not applied, such as when the engine stops and the like. The hydraulic circuit supplies hydraulic pressure from the oil pump to the tensioner body 83 when the engine is operated.

With respect to the horizontally opposed engine 1 as seen in FIG. 3, when the engine is operated, the crankshaft 2 rotates in a clockwise direction and the timing chain 12 rotates in a counterclockwise direction.

The second laterally extending section 73 is wound so that it extends substantially parallel with the axis C of the cylinder between the first camshaft side sprocket 53 and the second camshaft side sprocket 54. Therefore, according to the present preferred embodiment, the length of the second laterally extending section 73 can be minimized. Thus, if the timing chain 12 becomes elongated, the rotational phase of the second camshaft side sprocket 54 is prevented from differing from the rotational phase of the first camshaft side sprocket 53 because the length of the second laterally extending section 73 is minimized.

As a result, in the horizontally opposed engine 1 according to the present preferred embodiment, although rotation of the crankshaft 2 is transmitted to the first camshaft 43 and the second camshaft 44 using the single timing chain 12, the engine operation is hardly affected by any elongation of the timing chain 12, thereby permitting valve timing between the intake valve 48 and the exhaust valve 49 to remain precise for a long period of time.

In the horizontally opposed engine 1 according to the present preferred embodiment, the water pump drive sprocket 62, which is preferably made of lightweight resin or plastic having a relatively low hardness, couples with the timing chain 12, which extends along the upper chain guide 76, at a substantially straight portion (second laterally extending section 73) through about one or two teeth provided on its circumference. The reasons for including a smaller winding angle are: (1) the water pump 55 can be driven with a relatively small load; and (2) an excessive load will not be applied on the teeth of the sprocket because any impact applied to the sprocket by the timing chain will be absorbed by the fluid in the water pump.

According to the present preferred embodiment, when an impact is applied to the water pump drive sprocket 62 by the timing chain 12, for example, due to a rotational variation of the engine 1, this impact will be absorbed by an elastic deformation of the teeth.

Therefore, because the water pump drive sprocket 62 couples with a substantially straight portion of the timing chain 12 thereby making the number of teeth coupled with the timing chain to be relatively small, the water pump drive sprocket 62 can be prevented from breakage resulting from an impact by the timing chain 12. In addition, because the impact is absorbed as described above, the timing chain 12 does not strongly grind on the teeth of the water pump drive sprocket 62 thereby minimizing wear of the teeth.

According to the present preferred embodiment, a space surrounding the oil pump drive sprocket 39 located at a lowermost portion of the chain chamber 65 is connected to the oil pan 19. In the present preferred embodiment, the oil pump drive sprocket 39 and a portion of the timing chain 12 wound around the sprocket 39 are coated in oil. The sprocket 39 and the timing chain 12 can be lubricated by oil that drips into the oil pan 19.

According to the present preferred embodiment, the oil pump 21 is preferably attached to a portion in the first cylinder body 5 that opposes the second cylinder body 8. Therefore, both an attachment of the oil pump 21 to the first cylinder body 5 and a detachment of the oil pump 21 from the first cylinder body 5 can be performed without requiring the second cylinder body 8 to be detached from the first cylinder body 5, or for there to be an open space surrounding the oil pump 21. Accordingly, the oil pump 21 can be easily attached or detached even though the oil pump is positioned in the engine 1.

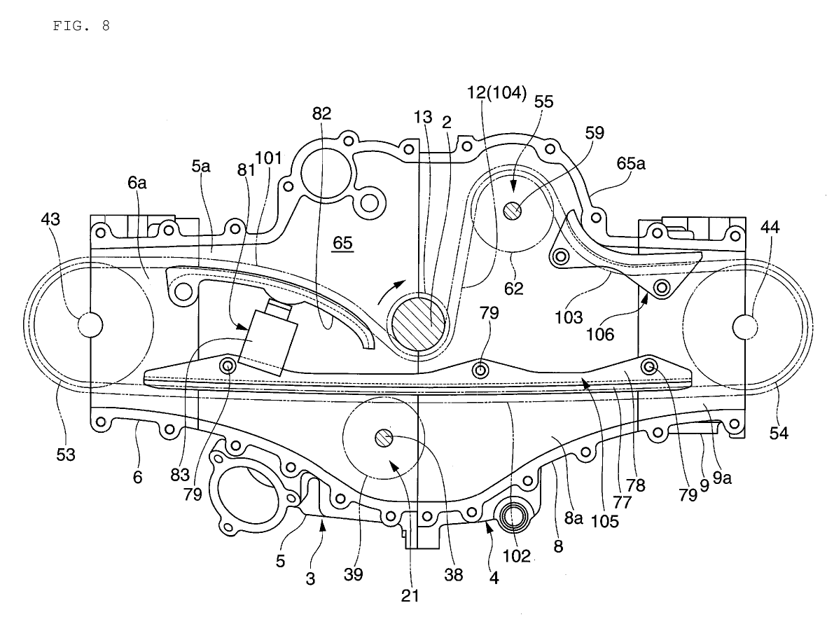

As shown in FIG. 8, a portion of the timing chain that extends in a substantially straight direction may be positioned below the crankshaft.

FIG. 8 is a front view of a horizontally opposed engine illustrating another preferred embodiment of the present invention. FIG. 8 is illustrated without a front cover and with a head cover depicted in breakaway. In FIG. 8, elements identical with or equivalent to those described in FIGS. 1 to 7 are denoted by the same reference numerals, and detailed description of such elements will be omitted as appropriate.

A timing chain 12, shown in FIG. 8, includes a first laterally extending section 101 extending laterally between the crankshaft side sprocket 13 and the first camshaft side sprocket 53; a second laterally extending section 102 extending substantially parallel with the axis C of the cylinder between the first camshaft side sprocket 53 and the second camshaft side sprocket 54; a third laterally extending section 103 extending laterally between the second camshaft side sprocket 54 and the water pump drive sprocket 62; and a vertically extending section 104 extending vertically between the water pump drive sprocket 62 and the crankshaft side sprocket 13.

The first laterally extending section 101 is urged upward by a hydraulic chain tensioner 81.

The second laterally extending section 102 according to the present preferred embodiment is positioned below the crankshaft 2 and connects between the lower end of the first camshaft side sprocket 53 and the lower end of the second camshaft side sprocket 54. The movement of the second laterally extending section 102 is limited in the upward and axial directions of the crankshaft 2 by a lower chain guide 105 attached to the first and the second cylinder bodies 5, 8. The lower chain guide 105 is configured the same as the upper chain guide 76 shown in a previous one of the preferred embodiments.

The oil pump drive sprocket 39 in the present preferred embodiment couples with a portion of the timing chain 12 defining the second laterally extending section 102 from below. Thus, since the oil pump drive sprocket 39 that couples with a portion of the timing chain 12 is made of plastic or resin, it can be prevented from being broken by an impact with the timing chain thereby minimizing wear of its teeth. In the present preferred embodiment, the oil pump drive sprocket 39 functions as an auxiliary drive sprocket.

The third laterally extending section 103 is curved by an upper chain guide 106 in order to avoid interference with an upper wall 65a of the chain chamber 65. The upper chain guide 106 is configured the same as the lower chain guide 75 shown in a previously described preferred embodiment.

The same effects as the previous preferred embodiments can be achieved in when a substantially straight portion (second laterally extending section 102) of the timing chain 12 is positioned below the crankshaft 2.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A horizontally opposed engine comprising:
a crankshaft;
a first cylinder and a second cylinder, the first cylinder extending in a first direction from the crankshaft and the second cylinder extending in a second direction from the crankshaft as viewed along an axial direction of the crankshaft;
a first camshaft disposed in the first cylinder;
a second camshaft disposed in the second cylinder;
a crankshaft side sprocket disposed on the crankshaft;
a first camshaft side sprocket disposed on the first camshaft;
a second camshaft side sprocket disposed on the second camshaft;
a single timing chain wound around the side sprockets; and
a substantially straight chain guide defining a guide rail for the timing chain; wherein
the timing chain is arranged so that it extends between the first camshaft side sprocket and the second camshaft side sprocket in a direction substantially parallel with an axis of the first and second cylinders.

2. The horizontally opposed engine according to claim 1, further comprising an auxiliary drive sprocket coupled with a portion of the timing chain that extends along the chain guide, and the auxiliary drive sprocket is made from a material having a lower hardness than the timing chain.

3. The horizontally opposed engine according to claim 1, further comprising an oil pump, an oil pan, and an oil pump drive sprocket; wherein
the chain guide is disposed above the crankshaft side sprocket;
a portion of the timing chain that is positioned higher than the first and the second camshaft side sprockets is held by the chain guide;
a portion of the timing chain that is positioned lower than the first and the second camshaft side sprockets is coupled with the crankshaft side sprocket and the oil pump drive sprocket;
the oil pump drive sprocket is positioned at substantially the same height as the oil pan arranged below the first and the second cylinders; and
a space surrounding the oil pump drive sprocket is adjacent to the oil pan.

4. The horizontally opposed engine according to claim 1, further comprising:
a first cylinder body defining a portion of the first cylinder; and
a second cylinder body defining a portion of the second cylinder; wherein
the first cylinder body and the second cylinder body are arranged to oppose each other; and
an oil pump is attached to a portion of one of the first and second cylinder bodies opposing a portion of the other of the first and second cylinder bodies.

5. The horizontally opposed engine according to claim 4, wherein an oil pump drive sprocket is integrally affixed to an idler shaft and rotated therewith, and the idler shaft includes an interface arranged to transmit rotation to a rotary shaft.

6. The horizontally opposed engine according to claim 5, wherein the interface arranged to transmit rotation to a rotary shaft includes a concave groove on an end of the idler shaft, and a plate-shaped member on an end of the rotary shaft that opposes the concave groove, and the plate-shaped member is received in the concave groove to transmit a rotation of the idler shaft to the rotary shaft.

7. The horizontally opposed engine according to claim 1, wherein the auxiliary drive sprocket includes a plurality of teeth arranged such that, during a rotation of the auxiliary drive sprocket, an impact occurs between the teeth of the auxiliary drive sprocket and the timing chain at a point where the timing chain couples with the teeth of the auxiliary drive sprocket, and the teeth of the auxiliary drive sprocket deform elastically during the impact between the teeth of the auxiliary drive sprocket and the timing chain.
